(19) United States
(12) Patent Application Publication
(10) Pub. No.: US 2024/0158024 A1
(43) Pub. Date: May 16, 2024

(54) METHOD AND SYSTEM FOR CONTROLLING A COVER, AND TRUCK-TRAILER COMBINATION

(71) Applicant: JOST-WERKE DEUTSCHLAND GMBH, Neu-Isenburg (DE)

(72) Inventors: José ALGÜERA, Aschaffenburg (DE); Stephan GITZEN, Riedstadt (DE); Michael FISCHER, Nagold (DE)

(21) Appl. No.: 18/550,522

(22) PCT Filed: Mar. 14, 2022
(86) PCT No.: PCT/EP2022/056507

§ 371 Date: Sep. 14, 2023

(30) Foreign Application Priority Data
Mar. 16, 2021 (DE) 10 2021 106 406.6

(51) Int. Cl. B62D 35/00; B62D 37/02

(52) U.S. Cl. CPC B62D 35/001; B62D 37/02

(57) ABSTRACT

A method for controlling a cover, which at least partially covers a gap (S) formed between a pulling vehicle and a pulled vehicle of a truck-trailer combination, by at least one actuator arranged to adjust the cover. In the method, a relative position and/or a relative orientation between the pulling vehicle and the pulled vehicle is determined, and the actuator is actuated depending on the relative position and/or the relative orientation.

### FIELD OF THE INVENTION

The present invention relates to a method for controlling a cover, a system for controlling a cover and a truck-trailer combination.

### BACKGROUND OF THE INVENTION

The group of truck-trailer combinations includes, in particular, semitrailer trucks and articulated trains. Semi-trailer trucks consist of a tractor as the pulling vehicle and a semitrailer (also called a trailer) as the pulled vehicle. An articulated train comprises a truck as the pulling vehicle and a trailer as the pulled vehicle.

It is known from the prior art that the gap located between the pulling vehicle and the pulled vehicle has a negative effect on fuel consumption. U.S. Pat. No. 6,428,084 B1 therefore discloses a system comprising covers designed to substantially close or cover the gap. An upper cover can be moved by means of a cylinder. The disclosed system provides that whenever reverse gear is engaged, the upper cover is moved upward so that the upper cover does not strike the semitrailer during the coupling operation and become damaged. The top cover is then moved downward, causing it to rest on the semitrailer.

DE 10 2009 054 570 A1 discloses a system having wind deflectors that bridge the gap to minimize turbulence between a tractor and a trailer vehicle. It is also disclosed that the wind deflector is only deployed when a minimum speed stored in a control unit is reached.

DE 10 2014 018 850 A1 discloses an air guidance system for a commercial vehicle, having at least one air guidance element held movably on a body of the commercial vehicle, and having at least one actuator by means of which the air guidance element can be moved relative to the body, wherein a sensor device is provided by means of which at least one distance of the air guidance element from a trailer coupled to the commercial vehicle can be determined and a distance signal characterizing the determined distance can be transmitted to the actuator, by means of which the air guidance element can be moved depending on the distance signal.

The known prior art systems lead to a reduction of flow resistance and fuel consumption. However, there is a need to further optimize the coverage of the gap.

### SUMMARY OF THE INVENTION

Thus, the object of the invention was to reduce the negative effects of the gap between a pulling and a pulled vehicle.

The solution to this object is provided by the method according to the invention.

According to the invention, it was recognized that the known systems inadequately cover the gap, especially while driving. The reason for this is primarily cornering. While the pulling and the pulled vehicle are oriented in the same way when driving straight ahead, a relative angle arises between the pulling and the pulled vehicle when driving around a curve. This can mean that the cover no longer completely covers the gap on one side or that the size of the cover must be selected from the outset so that the entire gap is not covered. In both cases, turbulence occurs during driving, which has a negative effect on fuel consumption.

According to the invention, therefore, a relative position and/or relative orientation between the pulling vehicle and the pulled vehicle is determined and the actuator is controlled depending on the relative position and/or relative orientation. In this way, the cover can be adapted to different situations during a journey, further reducing turbulence in the gap and reducing fuel consumption.

In the context of the present invention, the term position refers to the location of an object in space without regard to the orientation of the object. A change in position is caused by translational motion. The term orientation, on the other hand, refers to the orientation of an object in space without depending on its position. A change in orientation is caused by a rotational motion. A relative position can be specified by means of distances, a relative orientation by means of angles. In a Cartesian coordinate system, position is specified by three distances along the coordinate axes x,y,z and orientation is specified by three angles relative to the three coordinate axes. The position of a non-point object is preferably defined by its center of gravity.

Adjusting the cover is particularly understood as changing the position, orientation, shape or size of the cover or parts thereof. For example, the actuator may reciprocate, rotate, tilt, fold, telescope, displace, retract, extend, or inflate the cover or portions thereof. Generally, the cover is said to be extended or retracted.

To determine the relative position and/or relative orientation, preferably at least one of the following primary parameters is determined:
the angle of rotation at the coupling point between the pulling vehicle and the pulled vehicle
at least one distance between the vehicles
the absolute position of the pulling vehicle
the absolute position of the pulled vehicle
the absolute orientation of the pulling vehicle the absolute orientation of the pulled vehicle.

The angle of rotation at the coupling point can be determined by means of an angular measurement device. The angular measurement device can include, for example, a sensor on the pulling vehicle and measurement strips on the pulled vehicle. Starting from straight-ahead driving, the angle of rotation can thus be determined at any time.

Distances between the vehicles can be determined, for example, by means of distance sensors or by means of an optical system such as a camera or lidar. The relative position and/or relative orientation can be determined from the distances. The distances can also be determined/calculated from geometric information of the vehicles (width of the vehicles, height of the vehicles, etc.). The geometric information can be stored, for example, in the form of a OR code on the pulled vehicle. During coupling, the QR code is read and the distances are then determined from the geometric information of both vehicles and the actuator is controlled depending on these distances (see also below).

The absolute position of the vehicles can be determined, for example, by means of GPS (Global Positioning System). The absolute orientation can be determined, for example, by means of a compass and an inclinometer. From the absolute position or orientation of both vehicles, the relative position or relative orientation can be determined.

Preferably, the cover and the actuator are arranged on the pulling vehicle. Preferably, the actuator is controlled such that the cover abuts the pulled vehicle. However, it is also possible that the cover is always adjusted so that the coverage of the gap is as complete as possible, but the cover is not in contact with the pulled vehicle. This prevents damage to the cover. It is also possible that the cover is temporarily connected to the pulled vehicle, for example by means of a magnetic connection.

Another reason for insufficient coverage of the gap is the fact that there are different forms of vehicles in the case of both the pulling and the pulled vehicle. For example, in the case of a semitrailer, there are box trailers with a cuboid shape and tank trailers with a cylinder shape. Also, the pulled vehicle can have different widths or heights. Since a pulling vehicle is regularly used for different pulled vehicles, it is desirable to adapt the cover to these circumstances. It is also desirable to adapt the cover to different driving situations in order to always achieve the optimum coverage of the gap. Preferably, therefore, the actuator is controlled depending on at least one of the following secondary parameters:
a parameter of the outer contour of the pulling vehicle
a parameter of the outer contour of the pulled vehicle
the current speed of the combination
the time elapsed since a speed limit value was exceeded
the position of the combination
the temperature of the environment
the air pressure of the environment
the dynamic pressure at the front side of the pulling vehicle
the air pressure on at least one flank of the pulled vehicle or the pulling vehicle
the air pressure in the roof area of the pulled vehicle or the pulling vehicle
the air pressure in the gap between the pulling vehicle and the pulled vehicle
traffic signs determined
the braking condition
the steering condition.

The parameter of the outer contour of the pulling vehicle and/or the pulled vehicle is at least one of the following:
width of the vehicle
height of the vehicle
shape of the vehicle
presence of an accessory device
shape of the accessory device
size of the accessory device
the position of a coupling point on the vehicle.

The parameters of the outer contour make it possible to adjust the cover so that it is optimally adapted to the outer contour. For example, if an accessory device is present, particularly a refrigeration unit, the cover is adjusted during cornering so that it does not collide with the accessory device.

It may be desirable to extend the cover only in certain situations, in particular when driving straight ahead for a long time or on a highway. Based on the current speed of the combination, the time that has elapsed since a speed limit value was exceeded, and/or the position of the combination, such a situation can be detected and the actuator can be controlled depending on these parameters. It is also possible to detect such a situation by means of traffic sign detection. If, for example, a traffic sign indicating the start of a highway is detected, it can be concluded that the cover is to be extended.

Temperature and air pressure have an influence on the flow of air while driving. When the cover abuts the pulled vehicle, the flow of air causes lift-off forces that counteract the abutment of the cover against the pulled vehicle. The magnitude of the lift-off forces depends on the temperature and the air pressure, so it is advantageous to determine the temperature and/or the air pressure and to take these parameters into account when controlling the actuator.

From the braking state, for example, emergency braking can be detected, whereupon the actuator is preferably controlled in such a way that the cover is completely retracted or folded away.

The steering state of the pulling and/or the pulled vehicle has an influence on the future relative position and relative orientation of the two vehicles. In particular, the steering state includes information about the steering angle and/or steering angle gradient of the pulling vehicle. It is advantageous to take the steering state into account when controlling the actuator, since this means that the actuator can be controlled even before the actual change in relative position and relative orientation.

Alternatively or in addition to the parameters, at least one characteristic curve can also be provided in the database for each vehicle type, which specifies at which relative position and/or relative orientation the cover is to be adjusted and how, or how the actuators are to be controlled. The relative position and/or relative orientation can then be determined and the actuators controlled as specified by the characteristic curve. The database can be stored in a control unit of the pulled or the pulling vehicle. The database may also be stored at an external storage location to which the vehicle has access, for example via telematics.

During a coupling operation, an input may be generated indicating which vehicles have been coupled together. This input can be manual, in particular manual by the driver using an input device such as a touchscreen in the vehicle cabin. However, the input can also be generated automatically, for example by each vehicle, in particular each pulled vehicle, comprising an electronically readable information, for example a QR code or an information stored in an RFID chip. The input can also be stored in one of the control units of the pulled vehicle and can be retrieved via a CAN system. During coupling, the code is read out, in particular by a control unit of the pulling vehicle, and the required parameters or characteristics are obtained with respect from a database. Subsequently, the actuator can be controlled depending on the parameters and/or the characteristic curves.

The relative position and/or the relative orientation are preferably determined continuously and the actuator is preferably controlled continuously depending on the relative position and/or the relative orientation. This ensures at all times that the cover optimally covers the gap. The term continuous is understood to mean, in particular, recurring at fixed time intervals. The time intervals are selected in particular so that they are sufficiently small to avoid damage to the combination (including the cover or the actuator) at the respective speed of the combination and the adjustment time (reaction time) of the actuator and the cover.

Preferably, several covers are provided, each with at least one actuator, wherein the actuators are controlled independently and/or differently. In particular, the actuators can be controlled in such a way that one cover is retracted and another cover is extended. At the same time, a third cover cannot be adjusted, for example.

The actuator is preferably controlled in such a way that the cover abuts the pulled vehicle with a specified contact force. In this way, the gap is closed and slight movements of the vehicles during travel do not immediately cause gaps in the covering of the gap. The contact force is preferably determined depending on at least one of the secondary parameters. As described above, the lift-off forces acting on the cover depend in particular on the speed of the vehicle and on the ambient temperature and air pressure of the environment. Therefore, it is advantageous to determine the contact pressure force based on these parameters. Particularly preferably, the contact pressure force is selected such that it exceeds the expected or the actually measured lift-off forces, in particular by at least 5%. The lift-off forces can be determined by means of an air pressure measurement, for example by means of a Pitot tube.

The system according to the invention for controlling a cover that at least partially covers a gap formed between a pulling vehicle and a pulled vehicle of a truck-trailer combination comprises at least one actuator arranged to adjust the cover. The system comprises a control unit connected to the actuator, which is arranged to determine a relative position and/or a relative orientation between the pulling vehicle and the pulled vehicle and to control the actuator depending on the relative position and/or the relative orientation.

The actuator may be actuated electrically, electromagnetically, pneumatically, hydraulically, or mechanically. For example, the actuator may be a servomotor, a hydraulic or pneumatic cylinder, or an inflation device for the cover. The actuator is connected to the cover so that it can adjust it, for example via a linkage.

The cover may be one-piece or multi-piece. In particular, the cover may be inflatable or telescopic. The cover may also be a extendable roller blind or a bellows.

Preferably, the system includes an angular measurement device that determines the orientation of the pulling and pulled vehicles or the relative orientation of the pulling and pulled vehicles. For example, the angular measurement device may include a sensor on the pulling vehicle and measurement strips on the pulled vehicle. Starting from straight ahead driving, the angle of rotation can thus be determined at any time. The angular measurement device may also include a compass and inclinometers. An angular measurement device is a cost-effective way to determine the relative orientation of the vehicles. The angular measurement device is connected to the control unit.

The system may also include distance sensors and/or an optical system, such as a camera or lidar, by means of which distances between vehicles are determined. The relative position and/or relative orientation can be determined from the distances. The distance sensors and/or the optical system are connected to the control unit.

The system preferably comprises a sensor device which is arranged to determine the temperature and/or the air pressure of the environment. The sensor device is connected to the control unit. In this way, the sensor device can transmit data on temperature and/or air pressure to the control unit and the control unit can control the actuator depending on this data.

The system preferably comprises a database in which at least one characteristic curve and/or at least one of the following parameters is stored for different vehicle types:
a parameter of the outer contour of the pulling vehicle
a parameter of the outer contour of the pulled vehicle.

The parameters of the outer contour are in particular those mentioned above.

The control unit is then arranged to control the actuator based on the characteristic curve or the parameters. For example, as described above, the control unit can use the angular measurement device to determine the relative orientation of the vehicles and control the actuator according to a characteristic curve stored in the database.

In particular, the system according to the invention is arranged to carry out the method according to the invention.

The truck-trailer combination according to the invention comprises a pulling vehicle and a pulled vehicle, wherein the pulling vehicle and the pulled vehicle form a gap in between, and wherein at least one cover is provided which at least partially covers the gap. The combination comprises a system as described above.

The actuator of the system is connected to the cover such that it can adjust the cover. The actuator is connected to the control unit in such a way that the control unit can control the actuator and in this way adjust the cover.

The cover preferably automatically returns to its retracted position when the actuator is not acting on the cover, for example when it is off-power or off-pressure. The cover can be reset via a pretension, for example by means of a spring.

The cover may comprise multiple chambers that can be inflated independently by the actuator or multiple actuators. In this way, the cover may comprise not only a retracted state and an extended (inflated) state, but also multiple states in between.

The covers together preferably form a U-shape, in particular an upside-down U.

The control unit is preferably connected to a braking system of the pulling vehicle and arranged to determine the braking state. In this way, emergency braking can be detected by means of the control unit and the actuator can then be controlled in such a way that the cover is retracted.

The control unit is preferably connected to a steering system of the pulling vehicle and is arranged to detect the steering state. In particular, the control unit is arranged to detect the steering angle and/or the steering angle gradient of the pulling vehicle. In this way, the control unit can determine the steering state of the combination and take it into account when controlling the actuator.

The control unit is preferably connected to an optical recognition device of the pulling vehicle, which is arranged to detect traffic signs. In this way, the control unit can use the traffic signs to detect a highway drive and control the actuator in such a way that the cover is extended.

The control unit is preferably connected to a navigation system of the pulling vehicle. In this way, the control unit can use the position of the combination to detect a highway drive and then control the actuator so that the cover is extended.

The pulling vehicle is preferably a tractor and the pulled vehicle is preferably a semitrailer. Alternatively, the pulling vehicle is preferably a truck and the pulled vehicle is preferably a trailer. The pulling vehicle may also be a combination of a tractor and semitrailer and the pulled vehicle may be a trailer.

The method according to the invention particularly provides for the use of the system according to the invention or the truck-trailer combination according to the invention.

### BRIEF DESCRIPTION OF THE DRAWINGS

The invention is illustrated and described below by way of example with reference to the drawings. Therein it is shown:

FIG. 1 illustrates a semi-trailer truck in straight ahead driving in a plan view; and

FIG. 2 illustrates a plan view of the semi-trailer truck shown in FIG. 1 when cornering.

### DETAILED DESCRIPTION OF THE INVENTION

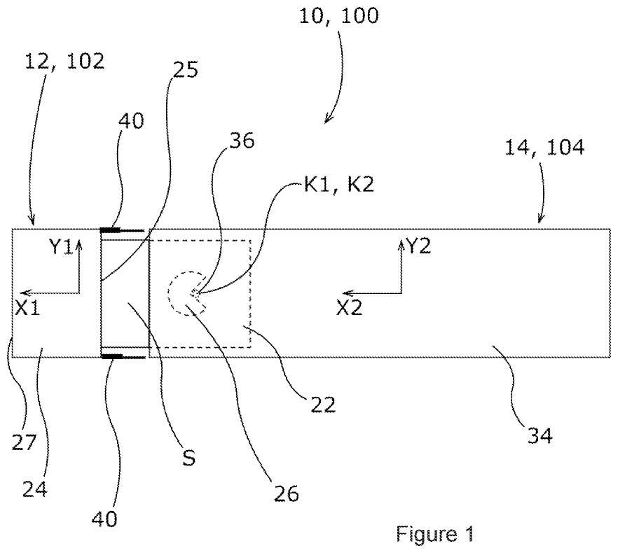

The semi-trailer truck 10 shown in FIG. 1 is a truck-trailer combination 100 with a tractor 12 as the pulling vehicle 102 and a semitrailer 14 as the pulled vehicle 104. FIG. 1 shows the semi-trailer truck 10 schematically and in straight ahead driving.

The tractor 12 includes a chassis 22, a driver's cabin 24, and at least four wheels (not shown). The orientation of the tractor 12 is determined in two dimensions by two axes X1 and Y1. The axis X1 corresponds to the direction in which the tractor 12 moves during straight ahead driving. The Y1 axis is perpendicular to the X1 axis and horizontal. The X1 and Y1 axes are fixed with respect to the tractor 12.

The tractor 12 includes a fifth wheel 26 by means of which it can be coupled to the semitrailer 14. The fifth wheel 26 defines the coupling point K1 of the tractor 12.

The semitrailer 14 comprises a chassis (not visible) and a body 34. The body 34 is here a box body. A king pin 36 is disposed in the front portion of the body 34, which interacts with the fifth wheel 26 to couple the tractor 12 and semitrailer 14. The king pin 36 defines the coupling point K2 of the semitrailer.

Since the semi-trailer truck 10 has the tractor 12 and semitrailer 14 coupled, the coupling points K1, K2 reside within each other.

The orientation of the semitrailer 14 is determined in two dimensions by the two axes X2 and Y2. The X2 axis corresponds to the direction in which the semitrailer 14 moves during straight ahead driving. The Y2 axis is perpendicular to the X2 axis and horizontal. The X2 and Y2 axes are fixed with respect to the semitrailer 14.

In straight ahead driving (FIG. 1), axes X1 and X2 are within each other and axes Y1 and Y2 are parallel to each other.

A gap S is formed between the tractor 12 and the semitrailer 14. Without further measures, the gap S leads to turbulence of the airstream during the travel of the semi-trailer truck 10. This would have a detrimental effect on the fuel consumption of the semi-trailer truck 10.

The tractor 12 comprises two covers 40. The covers 40 are disposed on a rear wall 25 of the driver's cabin 24 and extend in the X1 direction. As a result, the covers 40 partially cover or close the gap S. The covers 40 are each multi-part and telescopic by means of an actuator not shown. This allows the covers 40 to be extended and retracted steplessly.

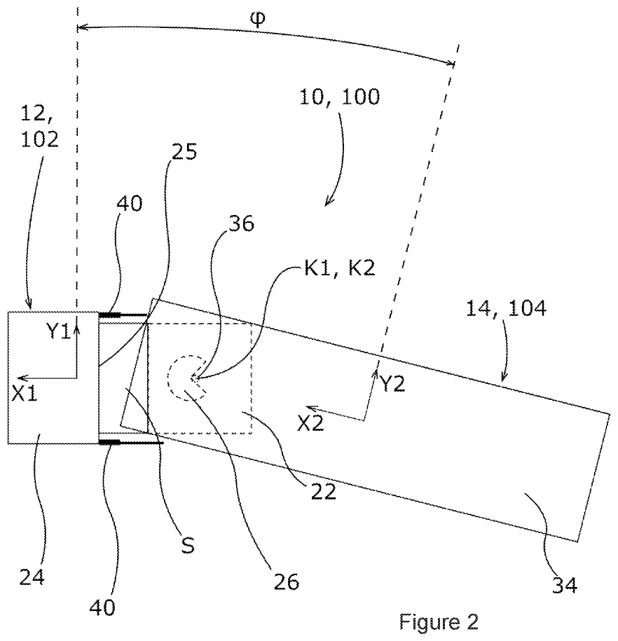

FIG. 2 shows the semi-trailer truck 10 cornering. The relative orientation between the tractor 12 and the semitrailer 14 changes as a result of cornering. This change is visible in that the axles Y1 and Y2 no longer run parallel, but at an angle φ≠0° (here about 15′). The relative position between tractor 12 and semitrailer 14 has also changed, since the centers of gravity of tractor 12 and semitrailer 14 are no longer on the common X1/X2 axis. The coupling points K1/K2 continue to lie within each other. The gap S has changed due to cornering, but is still present.

To determine the relative orientation and its change, the semi-trailer truck 10 comprises an angular measurement device connected to a control unit of the tractor 12 (both not shown). The angular measurement device detects a rotation of the semitrailer 14 about the common coupling point K1/K2 relative to the tractor 12, and the control unit can use this to determine the relative orientation of the tractor 12 and the semitrailer 14.

The control unit is connected to the actuators of the covers 40 in such a way that it can control the actuators and in this way retract and extend the covers 40. The control unit controls the actuators depending on the relative orientation. In FIG. 2, it can be seen that the cover 40 on the left side of the vehicle has been extended further compared with FIG. 1, so that the cover 40 continues to be closer to the semitrailer 14 and covers the gap S to a large extent. In this way, the gap can be largely closed even when cornering, thus avoiding turbulence and reducing fuel consumption.

The control unit includes a database in which characteristic curves are stored for various vehicle types (pulling and pulled vehicles). During the coupling process, an input is generated and transmitted to the control unit. The input provides the control unit with information about which vehicles have been coupled together. This input can be done manually. After receiving the input, the control unit can obtain the appropriate characteristic curve from the database and subsequently control the actuators depending on the characteristic curve.

### LIST OF REFERENCE SIGNS

10 Semi-trailer truck
12 Tractor unit
14 Semitrailer
22 Chassis
24 Driver's cabin
25 Rear wall
26 Fifth wheel
27 Front side
34 Body
36 King pin
40 Cover
100 Truck-trailer combination
102 Pulling vehicle
104 Pulled vehicle
K1 Coupling point
K2 Coupling point
S Gap
X1 Axis
X2 Axis
Y1 Axis
Y2 Axis

What is claimed is:

1. A method for controlling a cover which at least partially covers a gap (S) formed between a pulling vehicle and a pulled vehicle of a truck-trailer combination, by means of at least one actuator which is arranged to adjust the cover, comprising the steps of:
determining a relative position and/or a relative orientation between the pulling vehicle and the pulled vehicle and
controlling the actuator depending on the relative position and/or the relative orientation.

2. The method according to claim 1, wherein in order to determine the relative position and/or the relative orientation, at least one of the following primary parameters is determined:
the angle of rotation at the coupling point (K1, K2) between the pulling vehicle and the pulled vehicle
at least one distance between the vehicles
the absolute position of the pulling vehicle and the
the absolute position of the pulled vehicle
the absolute orientation of the pulling vehicle, and
the absolute orientation of the pulled vehicle.

3. The method according to claim 1, wherein the actuator is controlled depending on at least one of the following secondary parameters:
a parameter of the outer contour of the pulling vehicle
a parameter of the outer contour of the pulled vehicle
the current speed of the combination
the time elapsed since a speed limit value was exceeded
the position of the combination
the temperature of the environment
the air pressure of the environment
the dynamic pressure at the front side of the pulling vehicle
the air pressure on at least one flank of the pulled vehicle or the pulling vehicle
the air pressure in the roof area of the pulled vehicle or of the pulling vehicle
the air pressure in the gap (S) between the pulling vehicle and the pulled vehicle traffic signs determined
the braking condition, and
the steering condition.

4. The method according to claim 3, wherein the parameter of the outer contour of the pulling vehicle and/or the pulled vehicle is at least one of the following:
width of the vehicle
height of the vehicle
shape of the vehicle
presence of an accessory device
shape of the accessory device
size of the accessory device; and
the position of a coupling point (K1, K2) on the vehicle.

5. The method according to claim 1, wherein the relative position and/or the relative orientation is continuously determined and the actuator is continuously controlled depending on the relative position and/or the relative orientation.

6. The method according to claim 1, wherein a plurality of covers each having at least one actuator are provided, wherein the actuators are controlled independently and/or differently.

7. The method according to claim 3, wherein the actuator is controlled in such a way that the cover abuts the pulled vehicle with a fixed contact force.

8. The method according to claim 7, wherein the contact force is determined depending on at least one of the secondary parameters.

9. A system for controlling a cover that at least partially covers a gap (S) formed between a pulling vehicle and a pulled vehicle of a truck-trailer combination, comprising:
at least one actuator arranged to adjust the cover, and
a control unit connected to the actuator, arranged to determine a relative position and/or a relative orientation between the pulling vehicle and the pulled vehicle and to control the actuator depending on the relative position and/or the relative orientation.

10. The system according to claim 9, wherein the system comprises an angular measurement device that senses the orientation of the pulling vehicle and pulled vehicle or the relative orientation of the pulling vehicle and pulled vehicle.

11. The system according to claim 9, wherein the system comprises sensor device arranged to sense temperature and/or atmospheric pressure of the environment.

12. The system according to claim 9, wherein the system comprises a database in which at least one characteristic curve and/or at least one of the following parameters is stored for different vehicle types:
a parameter of the outer contour of the pulling vehicle
a parameter of the external contour of the pulled vehicle.

13. A truck-trailer combination comprising a pulling vehicle and a pulled vehicle, wherein the pulling vehicle and the pulled vehicle form a gap (S) in between, and wherein at least one cover is provided which at least partially covers the gap (S), and is controlled by the system according to claim 9.

14. The truck-trailer combination according to claim 13, wherein the control unit is connected to a braking system of the pulling vehicle and is arranged to determine the braking state.

15. The truck-trailer combination according to claim 13, wherein the control unit is connected to a steering system of the pulling vehicle and is arranged to determine the steering state.

16. The truck-trailer combination according to claim 13, wherein the control unit is connected to an optical recognition device of the pulling vehicle, which is arranged to detect traffic signs.

17. The truck-trailer combination according to claim 13, wherein the control unit is connected to a navigation system of the pulling vehicle.

18. The truck-trailer combination according to claim 13, wherein the pulling vehicle is a tractor and the pulled vehicle is a semitrailer, or in that the pulling vehicle is a truck and the pulled vehicle is a trailer.
